(19) United States
(12) Patent Application Publication
(10) Pub. No.: US 2013/0290451 A1
(43) Pub. Date: Oct. 31, 2013

(54) METHOD AND SYSTEM FOR LIMITING UNWANTED ON-LINE COMMUNICATION

(71) Applicant: PAGEBITES, INC., Palo Alto, CA (US)

(72) Inventors: Georges Harik, Palo Alto, CA (US); Ralph Harik, Palo Alto, CA (US); Nikola Borisov, Palo Alto, CA (US); Georgios Papoutsis, Menlo Park, CA (US)

(73) Assignee: PageBites, Inc.

(21) Appl. No.: 13/868,934

(22) Filed: Apr. 23, 2013

Related U.S. Application Data
(60) Provisional application No. 61/639,726, filed on Apr. 27, 2012.

(51) Int. Cl. H04L 12/58

(52) U.S. Cl. CPC H04L 51/12
USPC 709/206

(57) ABSTRACT

A method for controlling unwelcome communication among a network of users (a) maintains for each user an account to which communication units are credited by the network according to a schedule; and (b) for each user that initiates communication with a respondent user, the network (i) determines whether or not the account of the initiator user holds greater than a predetermined number of communication units; and (ii) when the account is determined to hold greater than the predetermined number of communicating units, deducts from the account of the initiator user the predetermined number of communication units, and allows the initiated communication to proceed.

### CROSS REFERENCE TO RELATED APPLICATIONS

The present application is related to and claims priority of U.S. Provisional Patent Application (“Copending Provisional Patent Application”), Ser. No. 61/639,726, entitled “Method and System for Limiting Unwanted On-line Communication,” filed on Apr. 27, 2012. The Copending Provisional Patent Application is hereby incorporated herein by reference in its entirety.

### BACKGROUND OF THE INVENTION

1. Field of the Invention

The present application relates to on-line communication; in particular, the present invention relates to a method for a user to limit receiving unwanted or unwelcome on-line communications using a market-based method.

2. Discussion of the Related Art

Often, services that allow users to contact each other on-line have problems with unwanted communication, also known as “spam.” Spam has been a problem on email networks, in instant messaging networks and in the newer social networks. In many of these services, the service provider uses a variety of techniques to determine whether or not communication is wanted. Some of these techniques are known as “spam filters”. These techniques have achieved various levels of success in the past.

### SUMMARY

According to one embodiment of the present invention, one technique for limiting unwanted communication uses a market mechanism, such as a currency system. In such a system, when one user or member of a network desires to communicate with a second member of the network, the first member is required to use this currency. One implementation provides this currency as “communication points” or CP.

In one embodiment, a system allows any member of the network to contact any other member of the network using CPs. The requirement of CPs for this contact represents a real cost to the initiator, and thus limits the spread of spam which proliferation depends on the fact that it is virtually free to the initiator. Such a cost becomes especially important when strangers are allowed to contact each other on such networks, but one may also use this mechanism to limit communications from another member when one cannot spend the time for such communication (e.g., when one is busy).

The present invention is better understood upon consideration of the detailed description in the following.

### BRIEF DESCRIPTION OF THE DRAWINGS

FIG. 1 shows communication system 100 implementing a communication points (CP) system, according to one embodiment of the present invention.

### DETAIL DESCRIPTION OF THE PREFERRED EMBODIMENTS

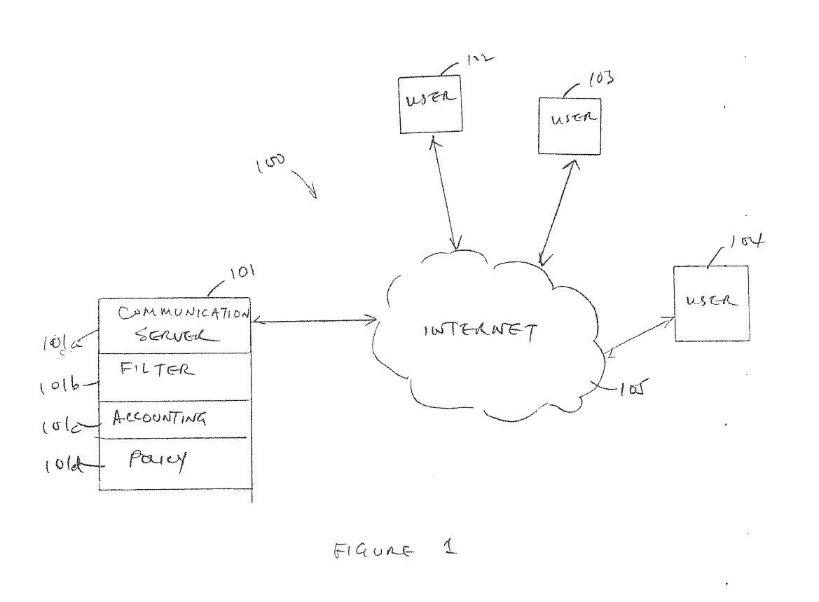

According to one embodiment of the invention, the communication points (CP) system may involve various subtle mechanisms to ensure that unwanted communications are kept to a minimum, while at the same time the cost imposed does not unduly or excessively limit desired, justifiable communication. FIG. 1 shows communication system 100 implementing a CP system, according to one embodiment of the present invention. As shown in FIG. 1, communication system 100 includes communication provider 101 serving users 102-104 over an information and communication network 105. Information and communication network 105 may be, for example, the Internet. Communication provider 101 may coordinate or provide services such as instant messaging, electronic mail, discussion groups and other social media services to users 102-104. To provide its services, as shown in FIG. 1, communication provider 101 may include communication server element 101a, which intermediates communication among users 102-104, such as relaying instant messages or discussion messages initiated by any of users 102-104 to their respective intended recipients. Communication provider may also include accounting element 101c, which manages allocation of CP to users 102-104 and deducting CP from their accounts as CP are expended in communication by the communicating parties. Communication provider 101 also includes filter element 102b, which analyzes both the environment and the content of the communication. For example, environment variables pertinent to communication system 100 may include the identities of users 102-104, the relationships among user 102-104 and the load or demand for communication at any time. The content of communication that is pertinent to communication system 100 includes, for example, the nature and relevance of the proposed message. A user's instruction that messages of a commercial nature are disfavored would affect the cost of sending a message with commercial content to such a user. Also, in a discussion group, an identification that a message is off-topic would increase cost of sending such a message to the discussion group. Communication provider 101 includes policy element 101d, which maintains the rules for costing communication and determines the cost of communication in any instance based on results from analysis of communication at filter element 101b. Accounting system element 101c maintains each user's CP account, according to application of rules in policy element 101d.

In one implementation, the CP system takes advantage of the fact that, in various forms of communication, the first contact in some time period (e.g., the first contact of the day) is readily distinguishable from further contacts in that same time period. Thus, in an instant messaging network, for example, the first instant message (IM) may cost the sender one (1) CP, but if the recipient responds (i.e., the initial message was well-received), further messages between the initiator and the recipient during an immediately following time period (e.g., next half-hour) may be free of charge. The initial cost of contact may be determined through filtering of messages flowing between the initiator and the recipient by an artificial intelligence program using factors such as, likelihood to respond by the recipient, which is in turn based on such factors as availability, average probability of responding, and a match between the initiator and the recipient. The match is determined based on, for example, their relative positions in a contact graph, their geographical proximity, the desirability of the initiator in other conversations, how busy the recipient is, how many recent messages the initiator has sent to the recipient without receiving back a response, how often the initiator has been blocked in making other contacts, and the time of day.

A similar approach may be used to admitting a member to participate in a discussion group (e.g., a public chat). Relevant consideration for assessing a number of CPs for the initiator to participate in the discussion includes: the identities of others in the discussions, the topic being discussed, and how often the initiator has been labeled as off topic. Various techniques, including machine learning techniques, can be applied to assess whether the content of a message is relevant or off-topic.

Alternatively, in such a network, a user may maintain a list of approved contacts. When a contact appears on an approved contact list, the contact may communicate with the owner of the approved contact list free of charge. In some embodiments, the system may require more CPs for certain forms of communication that are deemed more intrusive that others (e.g., voice calls). For example, in one embodiment, in addition to text communication, users can place audio and video calls, and send and receive photos and audio messages. Less intrusive communications (e.g., text messages) may require less CPs. Also, different costs can be charged for public messaging than private messaging, if it is desirable to encourage public messaging. Likewise, group messages or group calls may cost even more CPs, because such communication forms reach more recipients, and can potentially affect more people.

To seed such a system, a user may be given a daily allotment of a predetermined amount of CPs, and may be allowed to supplement his CP holdings by purchase. Such purchase may require use of a real-life currency (e.g., U.S. dollars). The daily allotment of CPs that a user may get may depend on a variety of factors. Some of the factors may relate to the demand by others to speak to that user. For example, the daily CP allotment to that user may depend on the user's contacts on the network and on other networks (e.g., how the user relates to other users in a connected graph). The CP allotment not only depends on the number of the user's contacts, but also the number of people who view that user as being distinguished or trustworthy on these networks. The demand for speaking with a user should roughly commensurate with the number of people who are willing to accept or respond to communication initiated by that user, and how often the user's broadcast messages are tagged. In addition, the number of CPs required to contact a given user may also depend on such factors, mirroring the fact that users who are in higher demand (for communication) in a market system will naturally have higher equilibrium prices than users who are in lesser demand. Further, a user should be granted extra CPs for willingness to reveal socially relevant personal information, e.g., employment, education, email domains the user has access to, and geographical location. A provider may provide a user a premium account type that grants a higher allotment of daily CPs when that user has demonstrated a greater trustworthiness (e.g., the user has been granted credit by a trusted source). A review system may be created for reviewing reports regarding a user's unwelcomed communication (e.g., harassing messages). An unfavorable review may result in a decrease of the user's daily CP allotment.

According to one aspect of this system, the initiator's costs of CPs should not be reimbursable by the respondent (i.e., the user to whom the communication is directed), as reimbursement introduces an incentive for a spammer to continuously harass the recipient to recover his “lost” CPs. The cost incurred in communicating with someone must be real, even in CPs; the cost consideration forces the initiator of a communication to seriously consider whether or not such communication may be reciprocated by the recipient, to avoid expending valuable resources (e.g., the CPs) in initiating the communication that could otherwise be more gainfully spent elsewhere. It is precisely because of such cost consideration that unwanted communication will be reduced under this system, as the initiator is forced to consider whether or not the communication is worth the CP cost incurred. Thus, a traditional market mechanism is used to control or avoid abuse of a valuable resource in communication systems (i.e., other people's time, a public good).

The above detailed description is provided to illustrate specific embodiments of the present invention and is not intended to be limiting. Numerous variations and modifications within the scope of the present invention are possible. The present invention is set forth in the following claims.

I claim:

1. A method for controlling unwelcome communication among a network of users, comprising:
maintaining for each user an account to which communication units are credited by the network according to a schedule; and
for each user that initiates communication with one or more respondent users in the network:
determining a number of communication units applicable to the communication to be initiated;
determining whether or not the account of the initiator user holds greater than the number of communication units determined; and
when the account is determined to hold greater than the number of communication units determined, deducting from the account of the initiator user the number of communication units determined, and allowing the initiated communication to proceed.

2. The method of claim 1, wherein the number of communication units is determined based upon whether or not the initiated communication is a first contact within a preceding time period.

3. The method of claim 1, wherein the number of communication units is determined based on whether or not each respondent user responded to the initiator in a previous communication.

4. The method of claim 1, further comprising filtering of messages communicated in the network.

5. The method of claim 4, wherein the number of communication units is determined based on a likelihood of response by each respondent user, the likelihood of response being determined based on analysis of the filtered messages.

6. The method of claim 5, wherein the filtered messages are analyzed according to one or more of the following factors: availability of each respondent user, average probability of responding by each respondent user, and a relationship between the initiator and each respondent user.

7. The method of claim 6, wherein the relationship between the initiator and each respondent user is determined based on relative positions in a contact graph, geographical proximity, a degree of acceptance of the initiator by others, a frequency of unsuccessful contact with the respondent by the initiator, a frequency of blocking of the initiator by others, and time of day.

8. The method of claim 1, wherein the initiated communication is an instant message.

9. The method of claim 1, wherein the respondent users are members of a discussion group or a public chat forum, and wherein the initiated communication comprises sending a message to the discussion group or the public chat forum.

10. The method of claim 9, wherein the number of communication units is determined based on one or more of: a topic being discussed in the discussion group or public chat and whether or not the initiator has been adjudged off-topic.

11. The method of claim 1, further comprising maintaining an approved contact list for each user and wherein the number of communication units is determined based on whether or not the initiator appears on the approved contact list of each respondent user.

12. The method of claim 1, wherein the number of communication units is determined based on one or more of: a measure of intrusiveness of the initiated communication, number of respondent users, and whether or not the initiated communication is public.

13. The method of claim 1, wherein each user account is increased by one or more of: a daily allotment of communication units and a purchase of communication units.

14. The method of claim 13, wherein the daily allotment of communication units is determined by one or more of: a desirability of the user, the user's connectedness to other users in the network, and personal information revealed by the user to the network.

15. The method of claim 14, wherein the desirability of the user is determined according to one of: number of users who view that user as being distinguished or trustworthy, number of users who are willing to accept or respond to communication initiated by that user, and how often the user's broadcast messages are tagged.

16. The method of claim 13, further comprising changing the daily allotment of communication units based on a review on a user's communication.

17. A system for controlling unwelcome communication among a network of users, comprising:
a communication server element that intermediates communication among the users;
an analysis element that analyzes and filters communication intermediated by the communication server element among the users;
a policy element that maintains rules of communication applicable to the communication among the users that is intermediated by the communication server; and
an accounting system element that maintains for each user a user account of communication units, wherein, for each communication intermediated at the request of an initiator, the accounting system deducts a number of communication units from the initiator's account.

18. The system of claim 17, wherein the accounting system element credits communication units to each user account according to a schedule.

19. The system of claim 17, wherein the policy element determines the number of communication units to be deducted based upon whether or not the initiated communication is a first contact within a preceding time period.

20. The system of claim 17, wherein the policy element determines the number of communication units based on whether or not each respondent user responded to the initiator in a previous communication.

21. The system of claim 17, wherein the analysis element determines a likelihood of response by each respondent user, the likelihood of response being determined based on analysis of the filtered messages.

22. The system of claim 21, wherein the filtered messages are analyzed according to one or more of the following factors: availability of each respondent user, average probability of responding by each respondent user, and a relationship between the initiator and each respondent user.

23. The system of claim 22, wherein the relationship between the initiator and each respondent user is determined based on relative positions in a contact graph, geographical proximity, a degree of acceptance of the initiator by others, a frequency of unsuccessful contact with the respondent by the initiator, a frequency of blocking of the initiator by others, and time of day.

24. The system of claim 17, wherein the initiated communication is one of: an instant message and a message sent to a discussion group or public chat forum.

25. The system of claim 24, wherein the policy element determines the number of communication units based on one or more of: a topic being discussed in the discussion group or public chat, and whether or not the initiator has been adjudged off-topic.

26. The system of claim 17, wherein each user is associated with an approved contact list and wherein the policy element determines the number of communication units based on whether or not the initiator appears on the approved contact list of each respondent user.

27. The system of claim 17, wherein the policy element determines the number of communication units based on one or more of: a measure of intrusiveness of the initiated communication, number of respondent users, and whether or not the initiated communication is public.

28. The system of claim 17, wherein the accounting system element increases each user account by one or more of: a daily allotment of communication units and a purchase of communication units.

29. The system of claim 28, wherein the daily allotment of communication units is determined by one or more of: a desirability of the user, the user's connectedness to other users in the network, and personal information revealed by the user to the network.

30. The system of claim 29, wherein the desirability of the user is determined according to one of: number of users who view that user as being distinguished or trustworthy, number of users who are willing to accept or respond to communication initiated by that user, and how often the user's broadcast messages are tagged.

31. The system of claim 28, wherein the accounting system element changes the daily allotment of communication units based on a review on a user's communication.

32. The system of claim 17, wherein communication comprise one or more of: text-based communication, audio and video calls, video clips, photographs and audio messages.

33. The method of claim 1, wherein communication comprise one or more of: text-based communication, audio and video calls, video clips, photographs and audio messages.
